(19) United States
(12) Patent Application Publication
(10) Pub. No.: US 2026/0241785 A1
(43) Pub. Date: Aug. 20, 2026

(54) THERMAL MANAGEMENT SYSTEM OF VEHICLE AND CONTROL METHOD OF THE SAME

(71) Applicants: Hyundai Motor Company, Seoul (KR); Kia Corporation, Seoul (KR)

(72) Inventors: Qing Dong HOU, Yantai (CN); Xiaorui ZHAI, Yantai (CN); Jia Ning JIN, Yantai (CN); Tae Hun JUNG, Hwaseong-Si (KR); Xueshan TANG, Yantai (CN)

(73) Assignees: Hyundai Motor Company, Seoul (CN); Kia Corporation, Seoul (CN)

(21) Appl. No.: 19/543,641

(22) Filed: Feb. 18, 2026

(30) Foreign Application Priority Data
Feb. 18, 2025 (CN) 202510174951.9

(51) Int. Cl. B60K 11/04; B60H 1/00; B60H 1/32; B60K 11/08

(52) U.S. Cl. CPC B60K 11/04; B60H 1/32281; B60K 11/085; B60H 2001/00307

(57) ABSTRACT

In a vehicle thermal management system and a method for controlling the same, the thermal management system includes an active air flap; a cooling fan, an ambient temperature sensor, a vehicle speed sensor, a cooling device including a first valve, a radiator, and a pump connected through a coolant line to cool an electrical component; and a bypass line connected to the coolant line through the first valve; an air conditioning device including a second valve connected through a refrigerant line and a heat-exchanger connected to the cooling device through a coolant line to exchange heat between the coolant and the refrigerant; a coolant temperature sensor to detect the temperature of the coolant flowing out of the heat-exchanger; and a controller to control the active air flap, the cooling fan, and the first valve according to the ambient temperature, the coolant temperature, and the vehicle speed.

### CROSS-REFERENCE TO RELATED APPLICATION

The present application claims priority to and the benefit of Chinese Patent Application No. 202510174951.9 filed with the Chinese National Intellectual Property Administration on Feb. 18, 2025, the entire contents of which are incorporated herein by reference.

### BACKGROUND OF THE PRESENT DISCLOSURE

### Field of the Present Disclosure

The present disclosure relates to a vehicle thermal management system and a control method thereof that may effectively utilize waste heat generated by an electrical component detected by a sensor.

### Description of Related Art

Electric vehicles do not have engines used in internal combustion engine vehicles, so they cannot use the engines' waste heat to heat the interior in cold environments. To achieve interior heating in cold environments, electric vehicles are typically equipped with electric heaters (e.g., positive temperature coefficient (PTC) heaters). However, if the heating is performed using the electric heater, the electrical energy consumption of the electric vehicle may increase, thereby shortening the driving range of the electric vehicle. Accordingly, it may hinder the popularization of electric vehicles.

To address the heating problem of electric vehicles in cold environments, various thermal management systems for use in electric vehicles have already been developed. These thermal management systems harvest heat from various sources to heat the interior of the vehicle. For example, heat sources may include heat from the outside air of the vehicle, and waste heat generated during the operation of various electrical component (e.g., a motor, an on-board charger (OBC), a high-voltage battery) installed in the electric vehicle.

However, conventional thermal management systems do not consider waste heat generated by electrical component when utilizing the waste heat from the electrical component, so the efficiency of utilizing the waste heat is low. Therefore, depending on the situation of the waste heat generated by the electric component, it is necessary to provide a vehicle heat management system and a control method thereof that may effectively utilize the waste heat.

The information contained in this Background section is directed to facilitate understanding of the background of the present disclosure and may include matters that are not related art and would already be known to those of ordinary skill in the art.

### BRIEF SUMMARY

According to various aspects of the present disclosure, a vehicle heat management system is provided that is configured for effectively utilizing waste heat generated by electrical component detected by a sensor.

According to various aspects of the present disclosure, a vehicle thermal management system may include an active air flap, a cooling fan, an ambient temperature sensor, a vehicle speed sensor, a cooling device, an air conditioning device, a coolant temperature sensor, and a controller. The cooling fan is disposed at the rear of a radiator; the ambient temperature sensor is used to detect an ambient temperature; the vehicle speed sensor is used to detect vehicle speed; the cooling device may include an electrical component, a first valve, the radiator, and a pump connected through a coolant line, and a bypass line branched from the coolant line and connected to the coolant line through the first valve to cool the electrical component; the air conditioning device may include a second valve connected through a refrigerant line and a heat-exchanger, the heat-exchanger being connected to the cooling device through the coolant line so that the coolant and the refrigerant exchange heat; the coolant temperature sensor is disposed downstream of the heat-exchanger on the coolant line and is used to detect a temperature of the coolant discharged from the heat-exchanger; and the controller may be configured to control operation of the active air flap, the cooling fan, and the first valve according to the ambient temperature, the coolant temperature, and the vehicle speed to execute one of the first mode, the second mode, and the third mode.

According to various aspects of the present disclosure, one end portion of the bypass line may be connected to the coolant line upstream of the radiator through the first valve, and the other end portion of the bypass line may be connected to the coolant line downstream of the radiator, so that the coolant flowing through the electrical component bypasses the radiator; the first valve may be a three-way valve, and a first port of the first valve may be connected to the radiator, a second port of the first valve may be connected to the heat-exchanger, and a third port of the first valve may be connected to the bypass line; and the second valve may be an expansion valve and may be disposed upstream of the heat-exchanger on the refrigerant line.

According to various aspects of the present disclosure, the controller may be configured to determine whether the coolant temperature is lower than the ambient temperature; if the coolant temperature is determined to be lower than the ambient temperature, to execute the first mode; if the coolant temperature is determined to be higher than the ambient temperature, to determine the coolant temperature to be lower than a first predetermined temperature; if the coolant temperature is determined to be lower than the first predetermined temperature, to execute the second mode; and if the coolant temperature is determined to be higher than the first predetermined temperature, to determine the third mode.

According to various aspects of the present disclosure, in the first mode, the controller may be configured to control the first valve to open the first port and the second port of the first valve and to close the third port; to determine whether a difference between the ambient temperature and the coolant temperature is greater than a second predetermined temperature; if the difference between the ambient temperature and the coolant temperature is determined to be greater than the second predetermined temperature, to control the cooling fan to operate at a first duty cycle; to determine whether the vehicle speed is lower than a first vehicle speed; if the vehicle speed is determined to be lower than the first vehicle speed, to control the active air flap to open; and if the vehicle speed is determined to be greater than or equal to the first vehicle speed, to control the active air flap to close.

According to various aspects of the present disclosure, in the first mode, the controller may be configured to control the cooling fan to operate at a second duty cycle that is smaller than the first duty cycle when it is determined that the difference between the ambient temperature and the coolant temperature is less than or equal to a second predetermined temperature; to determine whether the vehicle speed is lower than a second vehicle speed that is lower than the first vehicle speed; to control the active air flap to open when the vehicle speed is determined to be lower than the second vehicle speed; and to control the active air flap to close when the vehicle speed is determined to be greater than or equal to the second vehicle speed.

According to various aspects of the present disclosure, in the second mode, the controller may be configured to control the first valve to close the first port of the first valve and to open the second port and the third port, and to control the opening and closing of the active air flap and the duty cycle of the cooling fan according to a request of a motor control unit (MCU).

According to various aspects of the present disclosure, in the third mode, the controller may be configured to control the first valve to open the first port and the second port of the first valve and to close the third port, and to control the opening and closing of the active air flap and the duty cycle of the cooling fan according to the request of the MCU.

According to various aspects of the present disclosure, the first predetermined temperature and the second predetermined temperature may be determined by the ambient temperature.

A method for controlling the thermal management system of the vehicle according to another aspect of the present disclosure may include detecting the ambient temperature by the ambient temperature sensor; detecting the coolant temperature by the coolant temperature sensor; detecting the vehicle speed by the vehicle speed sensor; and controlling the operation of the active air flap, the cooling fan, and the first valve according to the ambient temperature, the coolant temperature, and the vehicle speed by the controller, thereby executing one of the first mode, the second mode, and the third mode.

According to various aspects of the present disclosure, the method may further include determining, by the controller, whether the coolant temperature is lower than the ambient temperature; determining, by the controller, the first mode if the coolant temperature is determined to be lower than the ambient temperature; determining, by the controller, whether the coolant temperature is lower than the first predetermined temperature if the coolant temperature is determined to be higher than the ambient temperature; determining, by the controller, the second mode if the coolant temperature is determined to be lower than the first predetermined temperature; and determining, by the controller, the third mode if the coolant temperature is determined to be higher than the first predetermined temperature.

According to various aspects of the present disclosure, in the first mode, the controller is configured to control the first valve to open the first port and the second port of the first valve and to close the third port; the controller is configured to determine whether the difference between the ambient temperature and the coolant temperature is greater than the second predetermined temperature; if the difference between the ambient temperature and the coolant temperature is determined to be greater than the second predetermined temperature, the controller is configured to control the cooling fan to operate at the first duty cycle; the controller is configured to determine whether the vehicle speed is lower than a first vehicle speed; if the vehicle speed is determined to be lower than the first vehicle speed, the controller is configured to control the active air flap to open; and if the vehicle speed is determined to be greater than or equal to the first vehicle speed, the controller is configured to control the active air flap to close.

According to various aspects of the present disclosure, in the first mode, if the difference between the ambient temperature and the coolant temperature is determined to be less than or equal to a second predetermined temperature, the controller is configured to control the cooling fan to operate at a second duty cycle that is less than the first duty cycle; if the controller is configured to determine whether the vehicle speed is lower than a second vehicle speed that is lower than the first vehicle speed, the controller is configured to control the active air flap to open; if the vehicle speed is determined to be less than the second vehicle speed, the controller is configured to control the active air flap to close.

According to various aspects of the present disclosure, in the second mode, the controller is configured to control the first valve to close the first port of the first valve and to open the second port and the third port, and is configured to control the opening and closing of the active air flap and the duty cycle of the cooling fan according to the request of the motor control unit (MCU).

According to various aspects of the present disclosure, in the third mode, the controller is configured to control the first valve to open the first port and the second port of the first valve and to close the third port, and is configured to control the opening and closing of the active air flap and the duty cycle of the cooling fan according to the request of the MCU.

According to various aspects of the present disclosure, the first predetermined temperature and the second predetermined temperature may be determined by the ambient temperature.

According to various exemplary embodiments of the present disclosure, the waste heat situation generated in the electrical component may be determined based on the coolant temperature detected by the coolant temperature sensor disposed downstream of the heat-exchanger. If the waste heat generated by the vehicle is insufficient, the coolant may be used to absorb the heat of the outside air in the radiator, and the heat of the outside air absorbed in the heat-exchanger may be transferred to the air conditioning system of the vehicle. If the waste heat generated by the electrical component is sufficient, the waste heat generated by the electrical component may be recovered using the coolant, and the waste heat from the electrical component recovered in the heat-exchanger may be transferred to the air conditioning system of the vehicle. If the waste heat generated by the electrical component is excessive, the waste heat generated by the electrical component may be recovered using the coolant, while the electrical component may be dissipated using the radiator, and the waste heat from the electrical component recovered in the heat-exchanger may be transferred to the air conditioning system of the vehicle.

Furthermore, the effects that may be obtained or predicted according to the embodiments of the present disclosure are disclosed directly or implicitly in the detailed description of the embodiments of the present disclosure. That is, various effects predicted according to exemplary embodiments of the present disclosure will be disclosed in the detailed description to be provided later.

### BRIEF DESCRIPTION OF THE DRAWINGS

The above and other objects, features, and other advantages of the present disclosure may be more clearly understood through the detailed description presented below together with the drawings.

FIG. 1 is a schematic diagram illustrating a thermal management system of a vehicle according to an exemplary embodiment of the present disclosure.

FIG. 2 is a block diagram illustrating a thermal management system of a vehicle according to an exemplary embodiment of the present disclosure.

FIG. 3 is a schematic diagram showing a vehicle thermal management system according to an exemplary embodiment of the present disclosure operating in a first mode.

FIG. 4 is a schematic diagram showing a vehicle thermal management system according to an exemplary embodiment of the present disclosure operating in a second mode.

FIG. 5 is a schematic diagram showing a vehicle thermal management system according to an exemplary embodiment of the present disclosure operating in a third mode.

FIG. 6 is a flowchart illustrating a control method of a vehicle thermal management system according to an exemplary embodiment of the present disclosure.

It should be understood that the drawings are simplified representations of each feature to explain each feature of the basic principle of the present disclosure, and are not necessarily drawn to scale. In the drawings, the same reference numerals represent the same or equivalent portions of the present disclosure.

### DETAILED DESCRIPTION

The term “vehicle” or “vehicular” or other similar terms as used herein should be understood to include automobiles, private cars generally including sports utility vehicles (SUVs), buses, trucks, various commercial vehicles, watercraft including various boats and ships, aircraft, and the like, as well as hybrid vehicles, electric vehicles, plug-in hybrid electric vehicles, hydrogen-powered vehicles and other alternative-fuel vehicles (e.g., fuels derived from sources other than petroleum).

Although embodiments have been described as performing the exemplary process by using a plurality of units, it should be understood that the exemplary process may be performed by one or more modules. Also, it is important to understand that the term “a control unit” refers to a hardware device that includes a memory and a processor. The memory is configured to store a module, and the processor is specifically configured to execute said module to complete one or more processes as further described below.

The terms used in the text are for the purpose of describing embodiments only and are not intended to limit the present disclosure. The singular forms “a,” “an,” and “the” used herein also include a plural form unless the context clearly dictates otherwise. It is to be further understood that the term “comprising” as used herein specifies the presence of said features, values, steps, operations, elements and/or components, but does not exclude the presence or addition of one or more other features, values, steps, operations, elements, components and/or combinations thereof. As used herein, the term “and/or” includes any and all combinations of one or more of the associated listed items.

Hereinafter, a vehicle thermal management system and a control method thereof according to an exemplary embodiment of the present disclosure will be described with reference to the drawings.

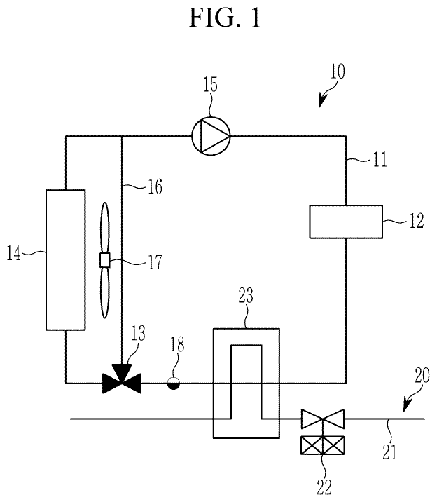

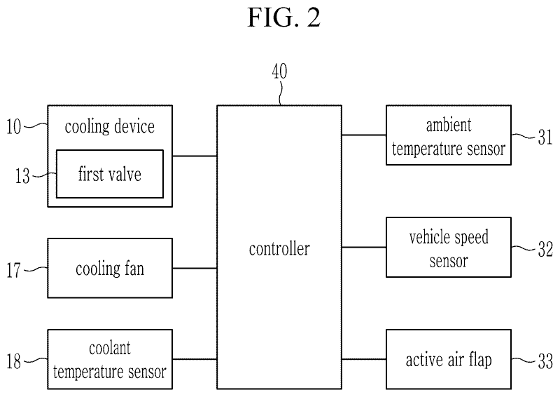

FIG. 1 is a schematic diagram illustrating a thermal management system of a vehicle according to an exemplary embodiment of the present disclosure, and FIG. 2 is a block diagram illustrating a thermal management system of a vehicle according to an exemplary embodiment of the present disclosure. Hereinafter, a vehicle thermal management system according to an exemplary embodiment of the present disclosure will be described in detail with reference to FIG. 1 and FIG. 2.

As illustrated in FIG. 1, a thermal management system of a vehicle according to an exemplary embodiment of the present disclosure may include a cooling device 10 and an air conditioning device 20.

In an exemplary embodiment of the present disclosure, the cooling device 10 may include an electrical component 12, a first valve 13, a radiator, 14 and a pump 15 connected via a coolant line 11. The cooling device 10 may cool the electrical component 12 by using coolant circulating in the coolant line 11. Additionally, the cooling device 10 may include a bypass line 16 connected to the coolant line 11 via the first valve 13 so as to bypass the radiator 14.

As an exemplary embodiment of the present disclosure, the electrical component 12 may include an onboard charger (OBC), a motor, a battery, and various vehicle controllers.

The first valve 13 may be a three-way valve.

The radiator 14 may cool the coolant circulating in the coolant line 11 by using the outside air of the vehicle.

The pump 15 may be an electric pump configured for circulating the coolant within the cooling device 10.

For the coolant flowing through the electrical component 12 to bypass the radiator 14, one end portion of the bypass line 16 may be connected to the coolant line 11 upstream of the radiator 14 through the first valve 13, and the other end portion of the bypass line 16 may be directly connected to the coolant line 11 downstream of the radiator 14. When the bypass line 16 and the coolant line 11 are connected through operation of the first valve 13, the coolant flowing through the electrical component 12 may not flow into the radiator 14. When the bypass line 16 and the coolant line 11 are blocked by operation of the first valve 13, the coolant flowing through the electrical component 12 may flow into the radiator 14.

Here, upstream and downstream refer to the direction in which the coolant flows.

Additionally, the thermal management system of the vehicle may include a cooling fan 17 disposed at the rear of the radiator 14. The cooling fan 17 may introduce outside air into the vehicle.

Here, forward and backward refer to the direction of the vehicle.

In an exemplary embodiment of the present disclosure, the air conditioning device 20 may include a second valve 22 and a heat-exchanger 23 connected via a refrigerant line 21. For simplicity, other components of the air conditioning device 20, such as the evaporator, condenser, and compressor, are omitted from the drawings.

The second valve 22 may be an electronic expansion valve and may be disposed upstream of the heat-exchanger 23 on the refrigerant line 21.

The heat-exchanger 23 may be connected to the cooling device 10 via the coolant line 11. The heat-exchanger 23 may be placed downstream of the electrical component 12 on the coolant line 11. Therefore, the coolant flowing out from the electrical component 12 may exchange heat with the refrigerant supplied from the air conditioning device 20 in the heat-exchanger 23.

The second valve 22 may selectively expand the refrigerant flowing into the heat-exchanger 23. When the second valve 22 introduces the refrigerant into the heat-exchanger 23 in an expanded state, the heat-exchanger 23 may be used as an evaporator. Therefore, the refrigerant in the refrigerant line 21 may be evaporated by exchanging heat with the coolant in the heat-exchanger 23. Therefore, the heat of the coolant in the coolant line 11 may be recovered using the heat-exchanger 23.

In an exemplary embodiment of the present disclosure, the first port of the first valve 13 may be connected to the coolant line 11 upstream of the radiator 14. The second port of the first valve 13 may be connected to the coolant line 11 downstream of the heat-exchanger 23. The third port of the first valve 13 may be connected to the bypass line 16.

When the first port and the second port of the first valve 13 are opened and the third port is closed, the bypass line 16 and the coolant line 11 are blocked, and the coolant flowing through the electrical component 12 may flow into the radiator 14. Therefore, the coolant may be cooled using the radiator 14. When the first port of the first valve 13 is closed and the second port and the third port are opened, the bypass line 16 and the coolant line 11 may be connected, and the coolant flowing through the electrical component 12 may flow into the bypass line 16 without flowing into the radiator 14.

Additionally, a coolant temperature sensor 18 is placed in the coolant line 11 downstream of the heat-exchanger 23. The coolant temperature sensor 18 may detect a temperature T_{COOLANT} of the coolant flowing out from the heat-exchanger 23. The temperature T_{COOLANT} of the coolant flowing out of the heat-exchanger 23 detected by the coolant temperature sensor 18 may reflect the level of waste heat generated by the electrical component 12. It means that the higher the coolant temperature T_{COOLANT}, the more waste heat is generated by the electrical component 12. Conversely, it means that the lower the coolant temperature T_{COOLANT}, the less waste heat is generated by the electrical component 12.

In cases where the waste heat generated by the electrical component 12 is insufficient (e.g., the coolant temperature T_{COOLANT} is lower than the ambient temperature), the coolant may be used to absorb the heat of the outside air of the vehicle. The first port and the second port of the first valve 13 are controlled to open and the third port is controlled to close so that the coolant flowing through the electrical component 12 may flow into the radiator 14, and the coolant may exchange heat with the outside air introduced through the cooling fan 17 in the radiator 14, thereby absorbing the heat of the outside air. Additionally, by using the heat-exchanger 23, the heat of the outside air may be recovered mainly through heat-exchange between the coolant and the refrigerant. Although not much waste heat is generated by the electrical component 12, the waste heat generated by the electrical component 12 may be recovered in the above process.

If the waste heat generated by the electrical component 12 is sufficient (for example, the coolant temperature T_{COOLANT} is higher than or equal to the ambient temperature), the waste heat generated by the electrical component 12 may be absorbed using the coolant. The first port of the first valve 13 is controlled to close and the second port and the third port are controlled to open, so that the coolant flowing through the electrical component 12 may flow into the bypass line 12 rather than into the radiator 14, and the coolant may absorb waste heat of the electrical component 12 when flowing through the electrical component 12. Additionally, the waste heat of the electrical component 12 may be recovered through heat-exchange between the coolant and the refrigerant by using the heat-exchanger 23.

When the waste heat generated by the electrical component 12 is excessive (for example, the coolant temperature T_{COOLANT} is higher than a predetermined temperature), the waste heat generated by the electrical component 12 may be absorbed by using the coolant while simultaneously dissipating the heat from the electrical component 12. The first port and the second port of the first valve 13 are controlled to open and the third port is controlled to close so that the coolant flowing through the electrical component 12 may flow into the radiator 14, and the coolant may absorb the waste heat of the electrical component 12 when flowing through the electrical component 12 and be cooled when flowing through the radiator 14. Additionally, the waste heat of the electrical component 12 may be recovered through the heat-exchange between the coolant and the refrigerant by using the heat-exchanger 23.

In an exemplary embodiment of the present disclosure, the thermal management system of the vehicle may further include an ambient temperature sensor 31, a vehicle speed sensor 32, and an active air flap 33.

The ambient temperature sensor 31 may be used to detect an ambient temperature T_{AMB}. The vehicle speed sensor 32 may be used to detect a vehicle speed V. The active air flap 33 may be disposed at the front of the vehicle and be used to introduce the outside air into the interior of the vehicle.

In an exemplary embodiment of the present disclosure, the thermal management system of the vehicle may further include a controller 40, which may be a controller of the air conditioning device 20 or a stand-alone controller. The controller 40 may communicate with the cooling device 10, the air conditioning device 20, the coolant temperature sensor 18, the ambient temperature sensor 31, the vehicle speed sensor 32, and the active air flap 33, receive various information necessary to control the thermal management system of the vehicle, and control the operation of each component. The controller 40 may communicate with each component via a Controller Area Network (CAN).

The controller 40 may be configured to determine one of the first mode, the second mode, and the third mode depending on the ambient temperature T_{AMB} and the coolant temperature T_{COOLANT}. Additionally, the controller 40 may execute the determined mode by controlling the operation of the active air flap 33, the cooling fan 17, and the first valve 13 according to the ambient temperature T_{AMB}, the coolant temperature T_{COOLANT}, and the vehicle speed V.

The first mode is a mode that is executed by the controller 40 when the waste heat of the electrical component 12 is insufficient, the second mode is a mode that is executed by the controller 40 when the waste heat of the electrical component 12 is sufficient, and the third mode is a mode that is executed by the controller 40 when the waste heat of the electrical component 12 is excessive.

If the coolant temperature T_{COOLANT} is lower than the ambient temperature T_{AMB}, it means that the waste heat generated by the electrical component 12 is insufficient. At the instant time, the controller 40 executes the first mode so that heat from the outside air may be absorbed by using the coolant.

If the coolant temperature T_{COOLANT} is higher than the ambient temperature T_{AMB}, it means that the waste heat generated by the electrical component 12 is sufficient, and the controller 40 may execute the second mode or the third mode. In the present situation, the controller 40 may additionally determine whether the waste heat generated by the electrical component 12 is sufficient or excessive.

If the coolant temperature T_{COOLANT} is lower than a first predetermined temperature T₁, it means that the waste heat generated by the electrical component 12 is sufficient. At the instant time, the controller 40 executes the second mode to recover the waste heat of the electrical component 12 by using the heat-exchanger 23.

Conversely, if the coolant temperature T_{COOLANT} is higher than the first predetermined temperature T₁, it means that the waste heat generated by the electrical component 12 is excessive. At the instant time, the controller 40 may execute the third mode to recover the waste heat from the electrical component 12 by using the heat-exchanger 23 and simultaneously dissipate heat from the electrical component 12 by using the radiator 14.

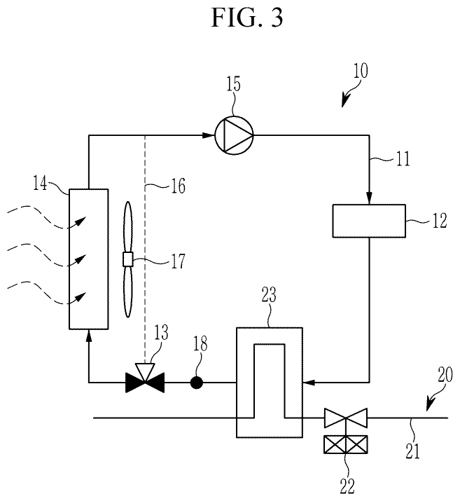

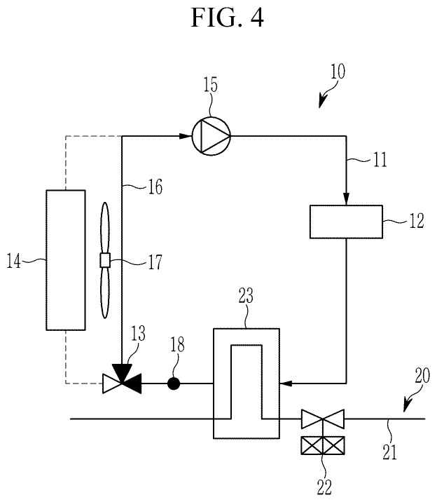

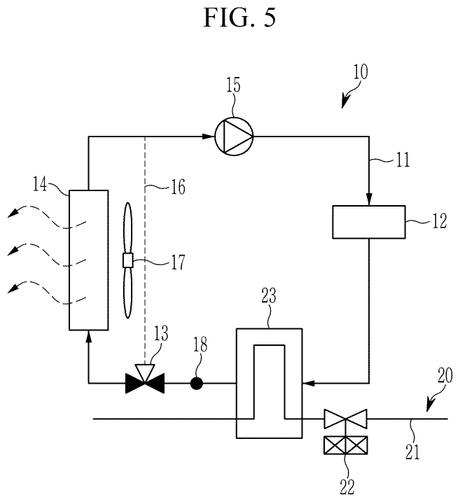

FIG. 3 is a schematic diagram showing a vehicle thermal management system according to an exemplary embodiment of the present disclosure operating in a first mode, FIG. 4 is a schematic diagram showing a vehicle thermal management system according to an exemplary embodiment of the present disclosure operating in a second mode, and FIG. 5 is a schematic diagram showing a vehicle thermal management system according to an exemplary embodiment of the present disclosure operating in a third mode. Hereinafter, with reference to FIG. 3 to FIG. 5, the first, second, and third modes of the vehicle thermal management system according to an exemplary embodiment of the present disclosure will be described in detail.

In an exemplary embodiment of the present disclosure, the controller 40 may communicate with the coolant temperature sensor 18 and the ambient temperature sensor 31 to receive the coolant temperature T_{COOLANT} detected by the coolant temperature sensor 18 and the ambient temperature T_{AMB} detected by the ambient temperature sensor 31. The controller 40 may be configured to determine whether the received coolant temperature T_{COOLANT} is lower than the ambient temperature T_{AMB}.

If the coolant temperature T_{COOLANT} is determined to be lower than the ambient temperature T_{AMB}, the controller 40 may execute the first mode. As shown in FIG. 3, in the first mode, the controller 40 may be configured for controlling the first valve 13 to open the first port and the second port of the first valve 13 and to close the third port. The coolant flowing through the electrical component 12 may be introduced into the radiator 14, and the coolant may exchange heat with the outside air introduced through the cooling fan 17 in the radiator 14, thereby absorbing the heat of the outside air. The coolant, whose temperature has increased by absorbing heat from the outside air, may flow through the pump 15 and the electrical component 12 and then into the heat-exchanger 23. Meanwhile, the second valve 22 of the air conditioning device 20 may be operated to cause the refrigerant flowing into the heat-exchanger 23 to expand. Accordingly, the coolant may evaporate the refrigerant by exchanging heat with the refrigerant supplied from the air conditioning device 20 in the heat-exchanger 23. Therefore, by using the heat-exchanger 23, the heat of the outside air may be recovered mainly through heat-exchange between the coolant and the refrigerant.

Additionally, in the first mode, the controller 40 may be configured for controlling the operation of the cooling fan 17 according to the difference between the ambient temperature T_{AMB} and the coolant temperature T_{COOLANT}.

The controller 40 may be configured to determine whether the difference between the ambient temperature T_{AMB} and the coolant temperature T_{COOLANT} is greater than a second predetermined temperature T₂. If the difference between the ambient temperature T_{AMB} and the coolant temperature T_{COOLANT} is determined to be greater than the second predetermined temperature T₂, it means that the temperature difference between the ambient temperature T_{AMB} and the coolant temperature T_{COOLANT} is large, and the controller 40 may be configured for controlling the cooling fan 17 to operate at a relatively large duty cycle so that more heat from the outside air may be absorbed.

For example, if the difference between the ambient temperature T_{AMB} and the coolant temperature T_{COOLANT} is determined to be greater than the second predetermined temperature T₂, the controller 40 may be configured for controlling the cooling fan 17 to operate at the first duty cycle. The first duty cycle may be 50%.

Additionally, in the first mode, the controller 40 may be configured for controlling the operation of the active air flap 33 according to the vehicle speed V.

The controller 40 may be configured to determine whether the vehicle speed Vis less than a first vehicle speed V₁. When the vehicle speed V is determined to be less than the first vehicle speed V₁, the controller 40 may be configured for controlling the active air flap 33 to open. When the vehicle speed V is determined to be greater than or equal to the first vehicle speed V₁, the controller 40 may be configured for controlling the active air flap 33 to close. In other words, the first vehicle speed V₁ may be determined as a threshold vehicle speed for controlling the opening and closing of the active air flap 33 when the temperature difference between the ambient temperature T_{AMB} and the coolant temperature T_{COOLANT} is large.

The reason for controlling the opening and closing of the active air flap 33 according to the vehicle speed V is that when the active air flap 33 is opened, wind resistance of the vehicle may increase, and if the active air flap 33 is opened when the vehicle speed V is high, relatively high energy loss may occur. To reduce energy loss, the active air flap 33 may be closed when the vehicle speed Vis high.

The first vehicle speed V₁ may be 85 kph.

Meanwhile, if the difference between the ambient temperature T_{AMB} and the coolant temperature T_{COOLANT} is less than or equal to the second predetermined temperature T₂, it means that the temperature difference between the ambient temperature T_{AMB} and the coolant temperature T_{COOLANT} is small. When the difference between the ambient temperature T_{AMB} and the coolant temperature T_{COOLANT} is determined to be less than or equal to the second predetermined temperature T₂, compared to the case where the difference between the ambient temperature T_{AMB} and the coolant temperature T_{COOLANT} IS greater than the second predetermined temperature T₂, the controller 40 may be configured for controlling the cooling fan 17 to operate at a smaller duty cycle.

For example, if the difference between the ambient temperature T_{AMB} and the coolant temperature T_{COOLANT} is determined to be less than or equal to the second predetermined temperature T₂, the controller 40 may be configured for controlling the cooling fan 17 to operate at a second duty cycle that is smaller than the first duty cycle. The second duty cycle may be 30%.

Additionally, the controller 40 may be configured to determine whether the vehicle speed V is less than the second vehicle speed V₂. When the vehicle speed V is determined to be less than the second vehicle speed V₂, the controller 40 may be configured for controlling the active air flap 33 to open. When the vehicle speed Vis determined to be greater than or equal to the second vehicle speed V₂, the controller 40 may be configured for controlling the active air flap 33 to close. In other words, the second vehicle speed V₂ may be determined as a threshold vehicle speed for controlling the opening and closing of the active air flap 33 when the temperature difference between the ambient temperature T_{AMB} and the coolant temperature T_{COOLANT} is small. The second vehicle speed V₂ may be less than the first vehicle speed V₁, and the second vehicle speed V₂ may be 45 kph.

That is, the threshold vehicle speed (i.e., the second vehicle speed V₂) when the temperature difference between the ambient temperature T_{AMB} and the coolant temperature T_{COOLANT} is small is set to be smaller than the threshold vehicle speed (the first vehicle speed V₁) when the temperature difference between the ambient temperature T_{AMB} and the coolant temperature T_{COOLANT} is large. When the active air flap 33 is opened, the heat absorbed from the outside air may increase, and to absorb the heat of the outside air as much as possible, the active air flap 33 is closed only when the temperature difference between the ambient temperature T_{AMB} and the coolant temperature T_{COOLANT} is large and the vehicle speed Vis high.

Therefore, in the first mode, the controller 40 is configured to control the operation of the active air flap 33, the cooling fan 17, and the first valve 13 according to the ambient temperature T_{AMB}, the coolant temperature T_{COOLANT}, and the vehicle speed V, so that the heat from the outside air may be absorbed when the waste heat generated by the electrical component 12 is insufficient.

In an exemplary embodiment of the present disclosure, the first predetermined temperature T₁ and the second predetermined temperature T₂ may be determined by the ambient temperature T_{AMB}. Table 1 below shows a mapping relationship between the first predetermined temperature T₁ and the ambient temperature T_{AMB}, and Table 2 shows a mapping relationship between the second predetermined temperature T₂ and the ambient temperature T_{AMB}.

TABLE 1

| T_{AMB} | T₁ |
|---|---|
| −20 | 45 |
| −15 | 45 |
| −10 | 45 |
| −5 | 30 |
| 0 | 20 |

As shown in Table 1, when the ambient temperature T_{AMB} is −10° C. or lower, the first predetermined temperature T₁ may be 45° C., when the ambient temperature T_{AMB} is higher than −10° C. and lower than −5° C., the first predetermined temperature T₁ may be 30° C., and when the ambient temperature T_{AMB} is higher than −5° C. and lower than 0° C., the first predetermined temperature T₁ may be 20° C. As the ambient temperature T_{AMB} increases, the temperature difference between the electrical component 12 and the ambient temperature T_{AMB} decreases, and the heat dissipation effect of the electrical component 12 worsens, so a temperature rise rate of the electrical component 12 increases faster. To preclude the rapid temperature rise of the electrical component 12, the first predetermined temperature T₁ is set to decrease as the ambient temperature T_{AMB} increases, so that the higher the ambient temperature T_{AMB}, the lower the coolant temperature T_{COOLANT} for determining whether to execute the third mode so that the third mode execution starts sooner.

TABLE 2

| T_{AMB} | T₂ |
|---|---|
| −20 | 1.5 |
| −15 | 1.5 |
| −10 | 1.5 |
| −5 | 2.0 |
| 0 | 3.0 |

As shown in Table 2, when the ambient temperature T_{AMB} is −10° C. or lower, the second predetermined temperature T₂ may be 1.5° C., when the ambient temperature T_{AMB} is higher than −10° C. and lower than −5° C., the second predetermined temperature T₂ may be 2° C., and when the ambient temperature T_{AMB} is higher than −5° C. and lower than 0° C., the second predetermined temperature T₂ may be 3° C.

When the ambient temperature T_{AMB} is high, even if the coolant temperature T_{COOLANT} is lower than the ambient temperature T_{AMB}, the heat may still be absorbed from the coolant to heat the vehicle interior. However, when the ambient temperature T_{AMB} is low, the temperature of the coolant temperature T_{COOLANT} is lower than the ambient temperature T_{AMB}, which means that it is difficult to absorb the heat from the coolant to heat the interior of the vehicle. By setting the second predetermined temperature T₂ to decrease as the ambient temperature T_{AMB} decreases, when the ambient temperature T_{AMB} is low, the cooling fan 17 may operate earlier with a larger duty cycle (i.e., the first duty cycle is larger than the second duty cycle), thereby absorbing heat from the outside air.

Table 1 and Table 2 only illustrate the mapping relationship between the first predetermined temperature T₁ and the second predetermined temperature T₂, and the ambient temperature T_{AMB}, and the exemplary embodiments of the present disclosure are not limited thereto, and the values in Table 1 and Table 2 may be changed as needed.

If the coolant temperature T_{COOLANT} is determined to be higher than the ambient temperature T_{AMB}, the controller 40 may be configured to determine as the second mode or the third mode. In the instant case, the controller 40 may additionally determine whether the coolant temperature T_{COOLANT} is lower than the first predetermined temperature T₁.

If the coolant temperature T_{COOLANT} is determined to be lower than the first predetermined temperature T₁, it means that the waste heat generated by the electrical component 12 is appropriate, and the controller 40 may be configured to determine as the second mode. As shown in FIG. 4, in the second mode, the controller 40 may be configured for controlling the first port of the first valve 13 to be closed and the second port and the third port to be opened. The coolant flowing through the electrical component 12 may flow into the bypass line 16 rather than into the radiator 14. When the coolant flows through the electrical component 12, it may absorb the waste heat of the electrical component 12, and the coolant, whose temperature has increased by absorbing the waste heat of the electrical component 12, may flow through the pump 15 and the electrical component 12 and then into the heat-exchanger 23. Meanwhile, the second valve 22 of the air conditioning device 20 may operate to expand the refrigerant flowing into the heat-exchanger 23. Accordingly, the coolant may evaporate the refrigerant by exchanging heat with the refrigerant supplied from the air conditioning device 20 in the heat-exchanger 23. Therefore, by using the heat-exchanger 23, the waste heat of the electrical component 12 may be recovered through heat-exchange between the coolant and the refrigerant.

Furthermore, in the second mode, the controller 40 may be configured for controlling the operation (e.g., the opening and closing) of the active air flap 33 and the operation (e.g., the duty cycle) of the cooling fan 17 according to the request of the MCU; since this belongs to the related art, a detailed description thereof is omitted here.

Therefore, in the second mode, the controller 40 may be configured for controlling the operation of the active air flap 33, the cooling fan 17, and the first valve 13 to recover the waste heat from the electrical component 12 when the waste heat generated by the electrical component 12 is sufficient.

If the coolant temperature T_{COOLANT} is determined to be higher than the first predetermined temperature T₁, it means that the waste heat generated by the electrical component 12 is excessive, and the controller 40 may be configured to determine as the third mode. As shown in FIG. 5, in the third mode, the controller 40 may be configured for controlling the first port and the second port of the first valve 13 to open and the third port to close. The coolant flowing through the electrical component 12 may be introduced into the radiator 14, and the coolant may exchange the heat with the outside air introduced through the cooling fan 17 in the radiator 14. When the coolant flows through the electrical component 12, it may absorb the waste heat of the electrical component 12, and the coolant, whose temperature has increased by absorbing the waste heat of the electrical component 12, may dissipate some of the heat when it flows through the radiator 14, and the coolant after dissipating the heat may flow through the pump 15 and the electrical component 12 and then flow into the heat-exchanger 23. Meanwhile, the second valve 22 of the air conditioning device 20 may be operated to cause the refrigerant introduced into the heat-exchanger 23 to expand. Accordingly, the coolant may exchange heat with the refrigerant supplied from the air conditioning unit 23 in the heat-exchanger 23 to evaporate the refrigerant. Therefore, by using the heat-exchanger 23, the waste heat of the electrical component 12 may be recovered through the heat-exchange between the coolant and the refrigerant.

Furthermore, in the third mode, the controller 40 may be configured for controlling the operation (e.g., the opening and closing) of the active air flap 33 and the operation (e.g., the duty cycle) of the cooling fan 17 according to the request of the MCU; since this belongs to the related art, a detailed description thereof is omitted here.

Therefore, in the third mode, the controller 40 may be configured for controlling the operation of the active air flap 33, the cooling fan 17, and the first valve 13 to recover the waste heat from the electrical component 12 and dissipate the heat from the electrical component 12 when the waste heat generated by the electrical component 12 is excessive.

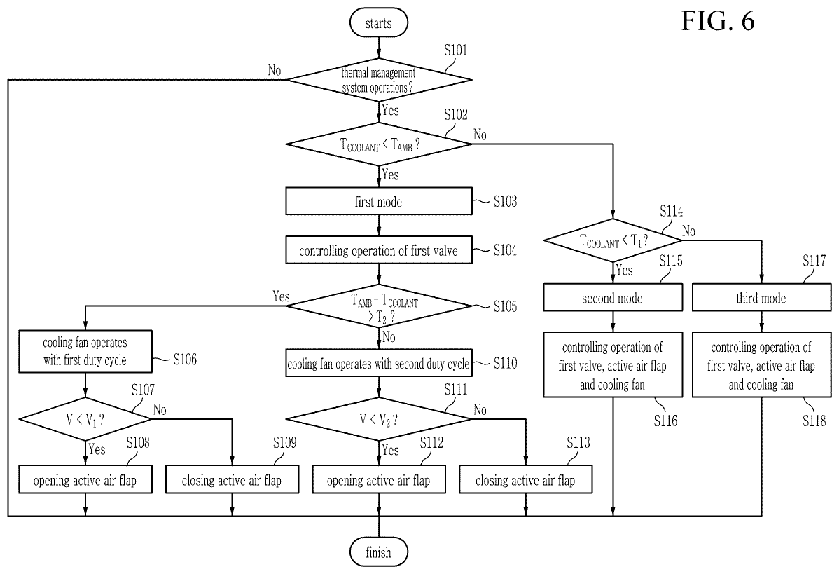

FIG. 6 is a flowchart illustrating a control method of a vehicle thermal management system according to an exemplary embodiment of the present disclosure. Steps (S101) to (S118) of the control method described below may be executed through the vehicle thermal management system illustrated in FIG. 1 to FIG. 5.

As illustrated in FIG. 6, in step (S101), the controller 40 may be configured to determine whether the thermal management system of the vehicle is operating. The controller 40 may be configured to determine whether the thermal management system of the vehicle is operating based on an operating signal of a compressor. When the compressor is operating, the thermal management system of the vehicle is configured to determine that it is operating.

If it is determined that the thermal management system of the vehicle is operating (“Yes” in step (S101)), in step (S102), the controller 40 may communicate with the coolant temperature sensor 18 and the ambient temperature sensor 31 to receive the coolant temperature T_{COOLANT} detected by the coolant temperature sensor 18 and the ambient temperature T_{AMB} detected by the ambient temperature sensor 31. The controller 40 may be configured to determine whether the coolant temperature T_{COOLANT} is lower than the ambient temperature T_{AMB} based on the received coolant temperature T_{COOLANT} and ambient temperature T_{AMB}.

If the coolant temperature T_{COOLANT} is determined to be lower than the ambient temperature T_{AMB} (“Yes” in step (S102)), in step (S103), the controller 40 may execute the first mode.

In the first mode, in step (S104), the controller 40 may be configured for controlling the operation of the first valve 13. The controller 40 may be configured for controlling to open the first port and the second port and close the third port.

In step (S105), the controller 40 may be configured to determine the second predetermined temperature T₂ corresponding to the ambient temperature T_{AMB} based on the above Table 2. Additionally, the controller 40 may be configured to determine whether the difference between the ambient temperature T_{AMB} and the coolant temperature T_{COOLANT} is greater than the second predetermined temperature T₂.

If the difference between the ambient temperature T_{AMB} and the coolant temperature T_{COOLANT} is determined to be greater than the second predetermined temperature T₂ (“Yes” in the step (S105)), in the step (S106), the controller 40 may be configured for controlling the cooling fan 17 to be operated with the first duty cycle. The first duty cycle may be 50%.

In the step (S107), the controller 40 may communicate with the vehicle speed sensor 32 and receive the vehicle speed V detected by the vehicle speed sensor 32. The controller 40 may be configured to determine whether the received vehicle speed V is less than the first vehicle speed V₁. The first vehicle speed V₁ may be 85 kph.

If the vehicle speed V is determined to be less than the first vehicle speed V₁ (“Yes” in step (S107)), in step (S108), the controller 40 may be configured for controlling the active air flap 33 to open.

If it is determined that the vehicle speed V is greater than or equal to the first vehicle speed V₁ (“No” in step (S107)), in step (S109), the controller 40 may be configured for controlling the active air flap 33 to close.

If it is determined that the difference between the ambient temperature T_{AMB} and the coolant temperature T_{COOLANT} is less than or equal to the second predetermined temperature T₂ (“No” in step (S105)), in step (S110), the controller 40 may be configured for controlling the cooling fan 17 to operate at a second duty cycle lower than the first duty cycle. The second duty cycle may be 30%.

In step (S111), the controller 40 may communicate with the vehicle speed sensor 32 and receive the vehicle speed V detected by the vehicle speed sensor 32. The controller 40 may be configured to determine whether the received vehicle speed V is less than the second vehicle speed V₂. The second vehicle speed V₂ may be 45 kph.

If the vehicle speed V is determined to be less than the second vehicle speed V₂ (“Yes” in step (S111)), in step (S112), the controller 40 may be configured for controlling the active air flap 33 to open.

If the vehicle speed V is determined to be greater than or equal to the second vehicle speed V₂ (“No” in step (S111)), in step (S113), the controller 40 may be configured for controlling the active air flap 33 to close.

If the coolant temperature T_{COOLANT} is determined to be higher than the ambient temperature T_{AMB} (“No” in the step (S102)), in the step (S114), the controller 40 may be configured to determine as the second mode or the third mode. Next, the controller 40 may be configured to determine the first predetermined temperature T₁ corresponding to the ambient temperature T_{AMB} based on the above Table 1. Additionally, the controller 40 may be configured to determine whether the coolant temperature T_{COOLANT} is lower than the first predetermined temperature T₁.

If the coolant temperature T_{COOLANT} is determined to be lower than the first predetermined temperature T₁ (“Yes” in step (S114)), in step (S115), the controller 40 may execute the second mode.

In the second mode, in step (S116), the controller 40 may be configured for controlling the operation of the first valve 13. The controller 40 may be configured for controlling to close the first port of the first valve 13 and open the second port and the third port. Additionally, the controller 40 may be configured for controlling the operation (e.g., the opening and closing) of the active air flap 33 and the operation (e.g., the duty cycle) of the cooling fan 17 according to the request of the MCU.

If the coolant temperature T_{COOLANT} is determined to be higher than the first predetermined temperature T₁ (“Yes” in step (S114)), in step (S117), the controller 40 may execute the third mode.

In the third mode, in step (S118), the controller 40 may be configured for controlling to open the first port and the second port of the first valve 13 and close the third port. Additionally, the controller 40 may be configured for controlling the operation (e.g., the opening and closing) of the active air flap and the operation (e.g., the duty cycle) of the cooling fan 17 according to the request of the MCU.

The vehicle thermal management system and the control method thereof according to an exemplary embodiment of the present disclosure may be configured to determine the waste heat situation generated in the electrical component based on the coolant temperature detected by the coolant temperature sensor disposed downstream of the heat-exchanger. If the waste heat generated by the vehicle is insufficient, the coolant may be used to absorb the heat of the outside air in the radiator, and the heat of the outside air absorbed in the heat-exchanger may be transferred to the air conditioning system of the vehicle. If the waste heat generated by the electrical component is sufficient, the waste heat generated by the electrical component may be recovered using the coolant, and the waste heat from the electrical component recovered in the heat-exchanger may be transferred to the air conditioning system of the vehicle. If the waste heat generated by the electrical component is excessive, the waste heat generated by the electrical component may be recovered by using the coolant, while the electrical component may be dissipated by using the radiator, and the waste heat from the electrical component recovered in the heat-exchanger may be transferred to the air conditioning system of the vehicle.

The vehicle thermal management system and the control method thereof according to an exemplary embodiment of the present disclosure may effectively utilize the waste heat generated by the electrical component according to the situation of the waste heat, thereby improving the efficiency of waste heat utilization.

Although the exemplary embodiments of the present disclosure have been described above, the present disclosure is not limited to the above embodiments, and includes all changes that could be easily made and deemed equivalent by a person including ordinary skill in the art to which the present disclosure pertains.

What is claimed is:

1. A thermal management system of a vehicle, the thermal management system comprising:
an active air flap;
a cooling fan disposed at a rear of a radiator;
an ambient temperature sensor detecting an ambient temperature;
a vehicle speed sensor detecting a vehicle speed;
a cooling device including an electrical component, a first valve, a radiator, and a pump connected through a coolant line through which a coolant flows, and a bypass line branched from the coolant line and connected to the coolant line through the first valve to cool the electrical component;
an air conditioning device including a second valve connected through a refrigerant line through which a refrigerant flows and a heat-exchanger connected to the cooling device through the coolant line to exchange heat between the coolant and the refrigerant;
a coolant temperature sensor disposed downstream of the heat-exchanger on the coolant line and detecting a temperature of the coolant flowing out of the heat-exchanger; and
a controller controlling operation of the active air flap, the cooling fan and the first valve according to the ambient temperature, the temperature of the coolant and the vehicle speed, thereby executing one of a first mode, a second mode, and a third mode.

2. The thermal management system of claim 1,
wherein a first end portion of the bypass line is connected to the coolant line upstream of the radiator through the first valve and a second end portion of the bypass line is connected to the coolant line downstream of the radiator so that the coolant flowing through the electrical component bypasses the radiator,
wherein the first valve is a three-way valve, a first port of the first valve is connected to the radiator, a second port of the first valve is connected to the heat-exchanger, and a third port of the first valve is connected to the bypass line, and
wherein the second valve is an expansion valve and is located upstream of the heat-exchanger on the refrigerant line.

3. The thermal management system of claim 2,
wherein the controller determines whether the temperature of the coolant is lower than the ambient temperature,
wherein based on that the temperature of the coolant is determined to be lower than the ambient temperature, the first mode is executed by the controller,
wherein based on that the temperature of the coolant is determined to be higher than the ambient temperature, the controller determines whether the temperature of the coolant is lower than a first predetermined temperature,
wherein based on that the temperature of the coolant is determined to be lower than the first predetermined temperature, the second mode is executed by the controller, and
wherein based on that the temperature of the coolant is determined to be equal to or higher than the first predetermined temperature, the third mode is executed by the controller.

4. The thermal management system of claim 3, wherein
in the first mode, the controller:
controls the first valve so that the first port and the second port of the first valve are opened and the third port is closed;
determines whether a difference between the ambient temperature and the temperature of the coolant is greater than a second predetermined temperature;
controls to operate the cooling fan with a first duty cycle based on that the difference between the ambient temperature and the temperature of the coolant is determined to be greater than the second predetermined temperature;
determines whether the vehicle speed is lower than a first vehicle speed;
controls to open the active air flap based on that the vehicle speed is determined to be lower than the first vehicle speed; and
controls to close the active air flap based on that the vehicle speed is determined to be greater than the first vehicle speed.

5. The thermal management system of claim 4, wherein
in the first mode, the controller:
controls to operate the cooling fan at a second duty cycle that is smaller than the first duty cycle based on that the difference between the ambient temperature and the temperature of the coolant is determined to be less than or equal to the second predetermined temperature;
determines whether the vehicle speed is lower than a second vehicle speed, which is lower than the first vehicle speed;
controls to open the active air flap based on that the vehicle speed is determined to be lower than the second vehicle speed; and
controls to close the active air flap based on that the vehicle speed is determined to be greater than or equal to the second vehicle speed.

6. The thermal management system of claim 3, wherein in the second mode, the controller controls the first valve to close the first port of the first valve and to open the second port and the third port, and controls opening and closing of the active air flap and a duty cycle of the cooling fan depending on a request of a motor control unit (MCU).

7. The thermal management system of claim 3, wherein in the third mode, the controller controls the first valve to open the first port and the second port of the first valve and to close the third port, and controls opening and closing of the active air flap and a duty cycle of the cooling fan depending on a request from an MCU.

8. The thermal management system of claim 3, wherein the first predetermined temperature is determined by the ambient temperature.

9. The thermal management system of claim 4, wherein the second predetermined temperature is determined by the ambient temperature.

10. A method for controlling the thermal management system of claim 1, the method comprising:
detecting the ambient temperature by the ambient temperature sensor;
detecting the temperature of the coolant by the coolant sensor;
detecting the vehicle speed by the vehicle speed sensor; and
controlling operation of the active air flap, the cooling fan and the first valve according to the ambient temperature, the temperature of the coolant and the vehicle speed by the controller to execute one of the first mode, the second mode and the third mode;

11. The method of claim 10, further comprising:
determining whether the temperature of the coolant is lower than the ambient temperature by the controller;
executing the first mode by the controller based on that the temperature of the coolant is determined to be lower than the ambient temperature;
executing by the controller whether the temperature of the coolant is lower than a first predetermined temperature based on that the temperature of the coolant is determined to be higher than the ambient temperature;
executing the second mode by the controller based on that the temperature of the coolant is determined to be lower than the first predetermined temperature; and
executing the third mode by the controller based on that the temperature of the coolant is determined to be higher than the first predetermined temperature.

12. The method of claim 11, further comprising: in the first mode,
controlling, by the controller, the first valve to open a first port and a second port of the first valve and to close a third port of the first valve;
determining, by the controller, whether a difference between the ambient temperature and the temperature of the coolant is greater than a second predetermined temperature;
controlling, by the controller, the cooling fan to operate at a first duty cycle based on that the difference between the ambient temperature and the temperature of the coolant is determined to be greater than the second predetermined temperature;
determining, by the controller, whether the vehicle speed is lower than a first vehicle speed;
controlling, by the controller, the active air flaps to open based on that the vehicle speed is determined to be lower than the first vehicle speed; and
controlling, by the controller, to close the active air flap based on that the vehicle speed is determined to be greater than the first vehicle speed.

13. The method of claim 12, further comprising: in the first mode,
controlling, by the controller, the cooling fan to operate at a second duty cycle that is smaller than the first duty cycle based on that the difference between the ambient temperature and the temperature of the coolant is determined to be less than or equal to a second predetermined temperature;
determining, by the controller, whether the vehicle speed is lower than a second vehicle speed which is lower than the first vehicle speed;
controlling, by the controller, the active air flaps to open based on that the vehicle speed is determined to be lower than the second vehicle speed;
controlling, by the controller, to close the active air flap based on that the vehicle speed is determined to be greater than or equal to the second vehicle speed.

14. The method of claim 11, further comprising: in the second mode, controlling, by the controller, the first valve to close a first port of the first valve and to open a second port and a third port of the first valve; and
controlling, by the controller, opening and closing of the active air flap and a duty cycle of the cooling fan according to a request from a motor control unit (MCU).

15. The method of claim 11, further comprising: in in the third mode,
controlling, by the controller, the first valve to open a first port and a second port of the first valve and to close a third port of the first valve; and
controlling, by the controller, opening and closing of the active air flap and a duty cycle of the cooling fan according to a request from an MCU.

16. The method of claim 11, wherein the first predetermined temperature is determined by the ambient temperature.

17. The method of claim 12, wherein the second predetermined temperature is determined by the ambient temperature.

18. A vehicle comprising of the thermal management system of claim 1.
